(19) United States
(12) Patent Application Publication
(10) Pub. No.: US 2003/0227588 A1
(43) Pub. Date: Dec. 11, 2003

(54) Reflective liquid crystal display

(76) Inventors: Chu-Jung Shih, Taipei (TW); Jr-Hong Chen, Hsinchu (TW); I-Min Lu, Taipei (TW)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/421,390

(22) Filed: Apr. 23, 2003

(30) Foreign Application Priority Data
Jun. 7, 2002 (TW) 091112347

(51) Int. Cl. G02F 1/1335

(52) U.S. Cl. 349/113

(57) ABSTRACT

A liquid crystal display includes a reflective pixel electrode, a transparent electrode, a liquid crystal layer and a transparent conductive layer. The transparent electrode cooperates with the reflective pixel electrode to provide a driving voltage. The liquid crystal layer includes a plurality of liquid crystal molecules and is sandwiched between the reflective pixel electrode and the transparent electrode to align in a predetermined manner in response to the driving voltage. The transparent conductive layer is disposed between the reflective pixel electrode and the liquid crystal layer for protecting the reflective pixel electrode and enhancing the reflectivity of the pixel electrode without undesirably consuming the driving voltage.

### FIELD OF THE INVENTION

The present invention relates to a liquid crystal display, and more particularly to a reflective liquid crystal display.

### BACKGROUND OF THE INVENTION

Liquid crystal displays (LCDs) are widely used in portable televisions, laptop personal computers, notebooks, electronic watches, calculators, mobile phones and office automation devices due to their advantages of small size, light weight, low driving voltage, low power consumption and good portability. LCDs are generally divided into three types: penetrative LCDs, reflective LCDs, and transflective LCDs. A penetrative LCD requires backlight, while a reflective LCD reflects environmental light. So far, reflective LCDs are relatively popular.

Referring to FIG. 1(a), a typical reflective LCD comprises a reflective pixel electrode layer 10, a liquid crystal layer 12 and a transparent electrode layer 13. The liquid crystal layer 12 contains a plurality of liquid crystal molecules and is sandwiched between the pixel electrode layer 10 and the transparent electrode layer 13. The liquid crystal molecules are aligned according to a driving voltage applied between the pixel electrodes 10 and the transparent electrode 13, thereby controlling light passing through the liquid crystal layer 12.

In order to acquire high reflectivity, the pixel electrodes 10 are made of metallic materials such as aluminum (Al), silver (Ag) and aluminum-neodymium (Al—Nd) alloy. Due to the metallic materials, the surfaces of the pixel electrodes 10 are readily corroded at the interface in contact with the liquid crystal molecules. Therefore, the reflectivity of the pixel electrodes 10 will be degraded for an extended period of time, and the brightness and color of the liquid crystal display are deteriorated.

For a purpose of improving the image quality, a liquid crystal display described in U.S. Pat. No. 5,926,240 employs a dielectric layer to overcome the above problem. The structure of such liquid crystal display is shown in FIG. 1(b). Referring to FIG. 1(b), a dielectric layer 11 is formed on the pixel electrodes 10, isolating the pixel electrodes from liquid crystal molecules. The dielectric layer 11 is usually made of silicon nitride and has a thickness in a range from 80 nm to 170 nm. The dielectric layer 11 serves as a passivation layer for protecting the pixel electrodes from corrosion. As known, corrosion results in the increasing roughness of the pixel electrode surface and thus renders reduced reflectivity. Furthermore, when the refractive index and the thickness of the dielectric layer 11 are well controlled, an optimal reflectivity of the pixel electrode is obtained accordingly. It is suggested that the refractive index be in a range from 1.6 to 1.9, and the thickness be from 80 nm to 170 nm.

Unfortunately, the overall capacitance of the liquid crystal display might be increased due to the presence of the dielectric layer 11 so as to consume the driving voltage applied between the pixel electrodes 10 and the transparent electrode 13. Since the effective voltage for driving the liquid crystal molecules in the liquid crystal layer 12 is reduced, it is required to raise the externally applied voltage from the driving circuit. Therefore, the liquid crystal display has relatively high power consumption.

### SUMMARY OF THE INVENTION

It is an object of the present invention to provide a reflective liquid crystal display capable of operating at a relatively small driving voltage compared to the prior art with the dielectric layer as a passivation layer.

It is another object of the present invention is to provide a reflective liquid crystal display having improved reflectivity of the pixel electrodes without adversely affecting driving voltage.

In accordance with an aspect of the present invention, there is provided a liquid crystal display. The liquid crystal display comprises a reflective pixel electrode, a transparent electrode, a liquid crystal layer and a transparent conductive layer. The transparent electrode cooperates with the reflective pixel electrode to provide therethrough a driving voltage. The liquid crystal layer comprises a plurality of liquid crystal molecules and sandwiched between the reflective pixel electrode and the transparent electrode to align in a predetermined manner in response to the driving voltage. The transparent conductive layer disposed between the reflective pixel electrode and the liquid crystal layer.

Generally, the reflective pixel electrode is made of a material selected from a group consisting of aluminum (Al), silver (Ag) and aluminum-neodymium (Al—Nd) alloy.

Preferably, the transparent conductive layer has a refractive index of at least 1.95. More preferably, the transparent conductive layer has a refractive index in a range from 1.95 to 2.2.

In an embodiment, the transparent conductive layer has a thickness in a range from 80 nm to 170 nm. And the transparent conductive layer is made of a material selected from a group consisting of indium tin oxide (ITO), indium zinc oxide (IZO) and conductive polymers.

In accordance with another aspect of the present invention, there is provided a liquid crystal display comprises a reflective pixel electrode, a transparent electrode, a liquid crystal layer and a protective layer. The liquid crystal layer comprises a plurality of liquid crystal molecules and sandwiched between the reflective pixel electrode and the transparent electrode, the liquid crystal molecules being controlled by a driving voltage applied between the reflective pixel electrode and the transparent electrode. The protective layer is disposed between the reflective pixel electrode and the liquid crystal layer for protecting the reflective pixel electrode from corrosion. Specially, the protective layer is transparent and conductive and has a refractive index of at least 1.95.

In accordance with another aspect of the present invention, there is provided a use of a transparent conductive layer for use in a liquid crystal display for protecting a pixel electrode layer from corrosion by a corrosive material.

In an embodiment, the corrosive material is liquid crystal molecule, and the transparent conductive layer is disposed between the pixel electrode layer and the liquid crystal molecule.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1(a) is a cross-sectional view illustrating a conventional liquid crystal display;

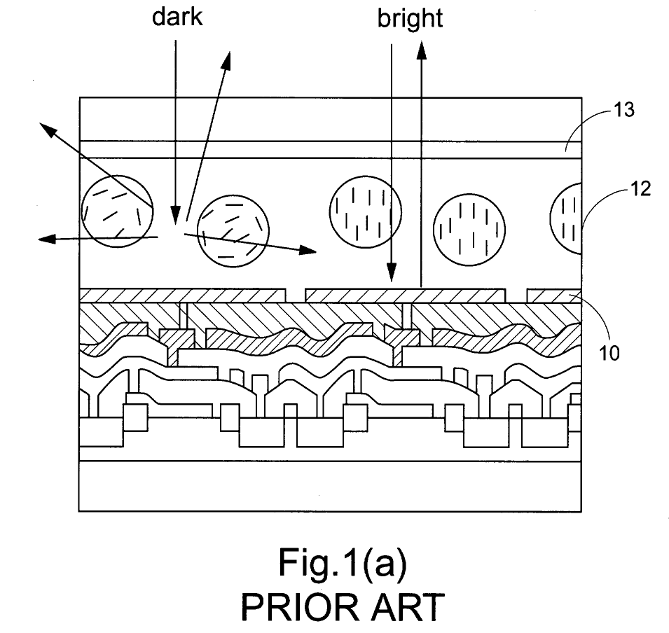

FIG. 1(b) is a cross-sectional view illustrating another conventional liquid crystal display; and

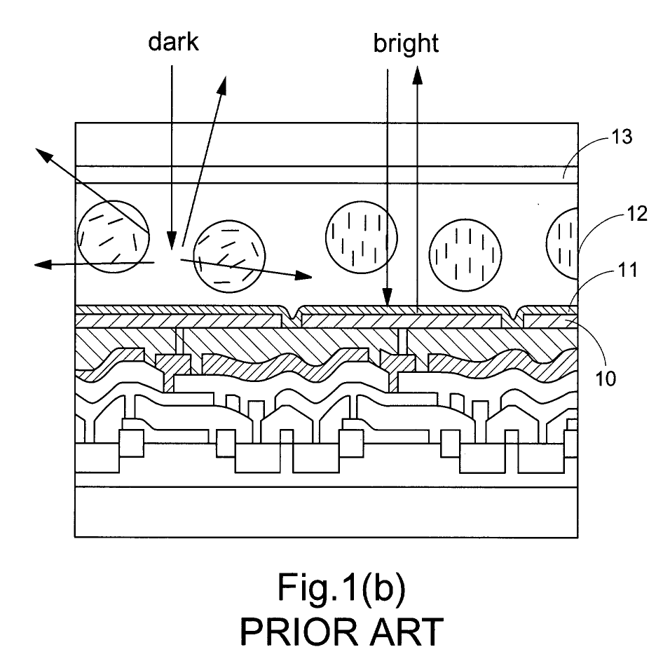

FIG. 2 is a cross-sectional view illustrating a liquid crystal display according to a preferred embodiment of the present invention.

### DETAILED DESCRIPTION OF THE PREFERRED EMBODIMENT

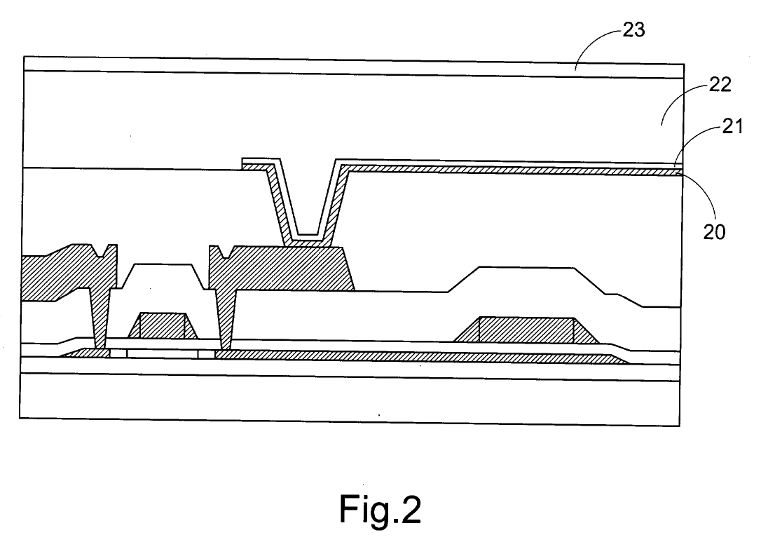

Referring to FIG. 2, the liquid crystal display of the present invention comprises reflective pixel electrodes 20, a transparent conductive layer 21, liquid crystal layer 22, and a transparent electrode 23.

For high performance, the pixel electrodes 20 are preferably made of a highly reflective metallic material such as aluminum (Al), silver (Ag) or aluminum-neodymium (Al—Nd) alloy. The liquid crystal layer 22 is sandwiched between the reflective pixel electrode 20 and the transparent electrode 23. The liquid crystal molecules are aligned in response to a driving voltage applied between the reflective pixel electrodes 20 and the transparent electrode 23, thereby controlling the brightness or darkness of the liquid crystal display. Since the operation principles relating to the liquid crystal molecules, the reflective pixel electrodes and the transparent electrode are well known in the art, it need not be further described in details herein.

In accordance with the present invention, the transparent conductive layer 21 is disposed between the reflective pixel electrode 20 and the liquid crystal layer 22 as a passivation layer for protecting the pixel electrodes from corrosion by the liquid crystal molecules. Therefore, the reflectivity of the pixel electrodes will not be adversely affected by the roughened surface of the pixel electrode layer resulting from corrosion. The transparent conductive layer 21 has a thickness in a range from 80 nm to 170 nm and is preferably selected from indium tin oxide (ITO), indium zinc oxide (IZO) and any other suitable conductive polymer. Due to the conductive feature of the transparent conductive layer, the driving voltage will not be undesirably consumed by the passivation layer as in the prior art. Furthermore, the transparent conductive layer 21 preferably has a refractive index of at least 1.95 that is higher than the refractive index of the silicon nitride dielectric layer, which is about 1.6˜1.9. For example, ITO has a refractive index of 1.95 to 2.2. For such a high refractive index, the reflectivity of the pixel electrode 21 is even improved.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A liquid crystal display comprising:
a reflective pixel electrode;
a transparent electrode cooperating with said reflective pixel electrode to provide a driving voltage;
a liquid crystal layer comprising a plurality of liquid crystal molecules and sandwiched between said reflective pixel electrode and said transparent electrode to align in a predetermined manner in response to said driving voltage; and
a transparent conductive layer disposed between said reflective pixel electrode and said liquid crystal layer.

2. The liquid crystal display according to claim 1 wherein said reflective pixel electrode is made of a material selected from a group consisting of aluminum (Al), silver (Ag) and aluminum-neodymium (Al—Nd) alloy.

3. The liquid crystal display according to claim 1 wherein said transparent conductive layer has a refractive index of at least 1.95.

4. The liquid crystal display according to claim 1 wherein said transparent conductive layer has a refractive index in a range from 1.95 to 2.2.

5. The liquid crystal display according to claim 1 wherein said transparent conductive layer has a thickness in a range from 80 nm to 170 nm.

6. The liquid crystal display according to claim 1 wherein said transparent conductive layer is made of a material selected from a group consisting of indium tin oxide (ITO), indium zinc oxide (IZO) and conductive polymers.

7. A liquid crystal display comprising:
a reflective pixel electrode;
a transparent electrode;
a liquid crystal layer comprising a plurality of liquid crystal molecules and sandwiched between said reflective pixel electrode and said transparent electrode, said liquid crystal molecules being controlled by a driving voltage applied between said reflective pixel electrode and said transparent electrode; and
a protective layer disposed between said reflective pixel electrode and said liquid crystal layer for protecting said reflective pixel electrode from corrosion, wherein said protective layer is transparent and conductive and has a refractive index of at least 1.95.

8. The liquid crystal display according to claim 7 wherein said reflective pixel electrode is made of a material selected from a group consisting of aluminum (Al), silver (Ag) and aluminum-neodymium (Al—Nd) alloy.

9. The liquid crystal display according to claim 7 wherein said protective layer has a refractive index in a range from 1.95 to 2.2.

10. The liquid crystal display according to claim 7 wherein said protective layer has a thickness in a range from 80 nm to 170 nm.

11. The liquid crystal display according to claim 7 wherein said transparent conductive layer is made of a material selected from a group consisting of indium tin oxide (ITO), indium zinc oxide (IZO) and conductive polymers.

12. A use of a transparent conductive layer for use in a liquid crystal display for protecting a pixel electrode layer from corrosion by a corrosive material.

13. The use according to claim 12 wherein said corrosive material is liquid crystal molecule, and said transparent conductive layer is disposed between said pixel electrode layer and said liquid crystal molecule.

14. The use according to claim 12 wherein said pixel electrode layer is made of a material selected from a group consisting of aluminum (Al), silver (Ag) and aluminum-neodymium (Al—Nd) alloy.

15. The use according to claim 12 wherein said transparent conductive layer has a refractive index of at least 1.95.

16. The use according to claim 12 wherein said transparent conductive layer has a refractive index in a range from 1.95 to 2.2.

17. The use according to claim 12 wherein said transparent conductive layer is made of a material selected from a group consisting of indium tin oxide (ITO), indium zinc oxide (IZO) and conductive polymers.
